(19) United States
(12) Patent Application Publication
(10) Pub. No.: US 2007/0085947 A1
(43) Pub. Date: Apr. 19, 2007

(54) Array substrate, method of manufacturing the same and liquid crystal display device having the same

(75) Inventors: Joo-Sun Yoon, Seoul (KR); Won-Sang Park, Yongin-si (KR)

Correspondence Address: F. CHAU & ASSOCIATES, LLC, 130 WOODBURY ROAD, WOODBURY, NY, 11797, US

(73) Assignee: Samsung Electronics Co., Ltd.

(21) Appl. No.: 11/490,342

(22) Filed: Jul. 20, 2006

(30) Foreign Application Priority Data
Oct. 19, 2005 (KR) 2005-98437

(51) Int. Cl. G02F 1/1335

(52) U.S. Cl. 349/113

(57) ABSTRACT

An array substrate includes a switching element, a pixel electrode and an insulating layer. The switching element is formed in a display area of a substrate. The insulating layer is formed on the substrate having the switching element formed thereon. The insulating layer includes a plurality of reflective particles reflecting light incident into an upper portion of the substrate. Therefore, the organic insulating layer having the reflective particles may reflect and transmit light, so that a process forming a conventional reflective electrode or embossing patterns may be unnecessary and a manufacturing process of the array substrate may be simplified.

### CROSS-REFERENCE TO RELATED APPLICATIONS

This application claims priority to Korean Patent Application No. 2005-98437 filed on Oct. 19, 2005, the contents of which are herein incorporated by reference in their entirety.

### BACKGROUND OF THE INVENTION

1. Technical Field

The present disclosure relates to an array substrate, a method of manufacturing the array substrate and a liquid crystal display device having the array substrate. More particularly, the present invention relates to an array substrate capable of simplifying a manufacturing process thereof, a method of manufacturing the array substrate and a liquid crystal display device having the array substrate.

2. Discussion of the Related Art

Liquid crystal display (LCD) devices, among various flat panel display devices, have a variety of characteristics including thinner thickness, lighter weight, lower driving voltage and lower power consumption compared to other display devices, such as cathode ray tube (CRT) devices, plasma display panel (PDP) devices, etc. As a result, LCD devices are widely employed for various electronic devices.

An LCD device may be classified into a transmissive-type LCD device, a reflective-type LCD device and a transflective-type LCD device. The transmissive-type LCD device displays an image by using light from a backlight assembly that is placed behind the rear face of an LCD panel. The reflective-type LCD device displays an image by using ambient light, such as sunlight, that enters the LCD panel through the front face of the LCD panel. The transflective-type LCD device is operated in a transmittance display mode in a dark environment, such as an indoor space, and is operated in a reflection display mode in a bright environment, such as an outdoor space. In the transmittance display mode, the transflective-type LCD device displays an image by using light generated from a backlight assembly. On the other hand, in the reflection display mode, the transflective-type LCD device displays an image by using ambient light.

The reflective-type LCD device and the transflective-type LCD device include a plurality of embossing patterns that increase a reflectivity and broaden a viewing angle. The embossing patterns are formed through a process including a deposition of an organic layer, an exposure of the organic layer, a developing of the organic layer and a deposition of a reflective layer.

Therefore, a method that simplifies a process of manufacturing the reflective-type LCD device and the transflective-type LCD device is required.

### SUMMARY OF THE INVENTION

Embodiments of the present invention provide an array substrate capable of simplifying a manufacturing process, a method of manufacturing the above-mentioned array substrate, and a liquid crystal display (LCD) device having the above-mentioned array substrate.

In an embodiment of the present invention, an array substrate includes a switching element, an insulating layer and a pixel electrode. The switching element is formed in a display area of a substrate. The insulating layer is formed on the substrate having the switching element formed thereon. The insulating layer includes a plurality of reflective particles reflecting a first light incident into an upper portion of the substrate. The pixel electrode is formed on the insulating layer. The pixel electrode is electrically connected to the switching element.

In an embodiment of the present invention, in order to manufacture an array substrate, a switching element is formed in a display area of a substrate. An insulating layer is formed on the substrate having the switching element formed thereon. The insulating layer includes a plurality of reflective particles reflecting a first light incident into an upper portion of the substrate. A pixel electrode is formed on the insulating layer. The pixel electrode is electrically connected to the switching element.

In an embodiment of the present invention, an LCD device includes a color filter substrate, an array substrate, and a liquid crystal layer. The array substrate faces the color filter substrate. The array substrate includes a switching element, a pixel electrode, and an insulating layer. The pixel electrode is electrically connected to the switching element. The insulating layer is formed on a substrate having the switching element formed thereon. The insulating layer includes a transmitting section that transmits a first light incident into a lower portion and a reflecting section that has reflective particles reflecting a second light through the color filter substrate. The liquid crystal layer is disposed between the color filter substrate and the array substrate.

According to the array substrate, method of manufacturing the array substrate and the LCD device having the array substrate, the organic insulating layer having a plurality of reflective particles may reflect and transmit light, so that a process forming a conventional reflective electrode or embossing patterns may be unnecessary and a manufacturing process of the array substrate may be simplified.

### BRIEF DESCRIPTION OF THE DRAWINGS

Exemplary embodiments of the present invention can be understood in more detail from the following descriptions taken in conjunction with the accompanying drawings, in which:

FIG. 1 is a cross-sectional view illustrating a portion of a liquid crystal display (LCD) device according to an exemplary embodiment of the present invention;

FIG. 2 is a plan view illustrating an array substrate in FIG. 1;

FIG. 3 is a cross-sectional view illustrating a reflective particle in FIG. 1;

FIGS. 4A to 4D are cross-sectional views illustrating a method of manufacturing an array substrate in FIG. 1, according to an exemplary embodiment; and

FIGS. 5A to 5C are cross-sectional views illustrating a method of manufacturing an array substrate in FIG. 1, according to an exemplary embodiment.

### DESCRIPTION OF THE EXEMPLARY EMBODIMENTS

The invention is described more fully hereinafter with reference to the accompanying drawings, in which embodiments of the invention are shown. This invention may, however, be embodied in many different forms and should not be construed as being limited to the embodiments set forth herein.

Hereinafter, an embodiment of the present invention will be explained in detail with reference to the accompanying drawings.

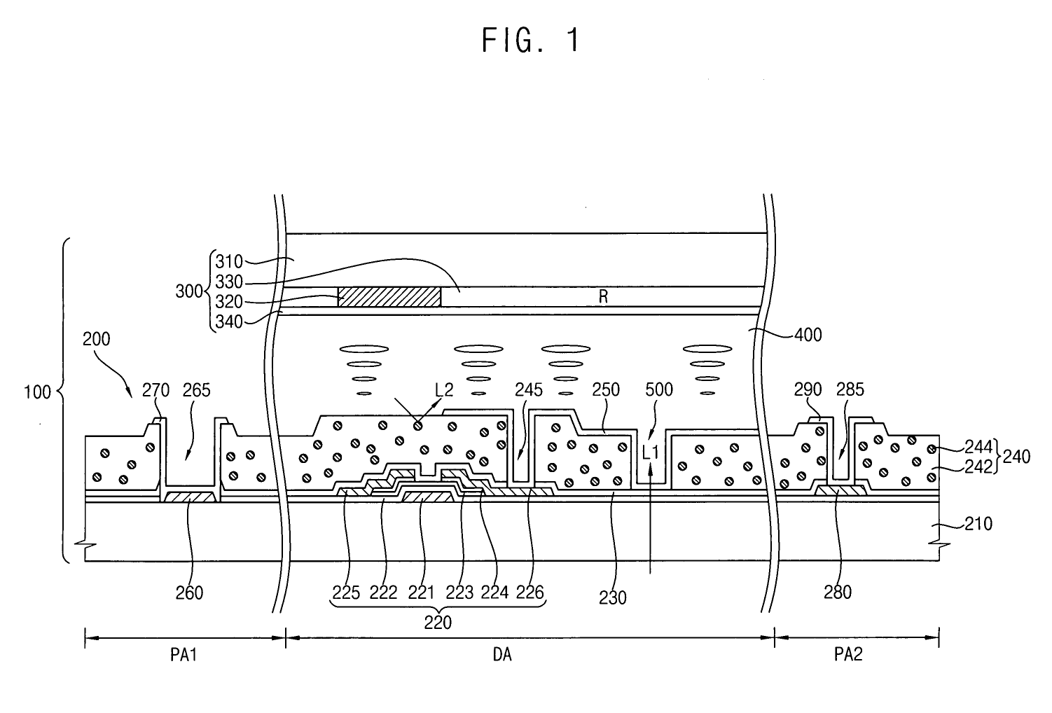

FIG. 1 is a cross-sectional view illustrating a portion of a liquid crystal display (LCD) device according to an exemplary embodiment of the present invention.

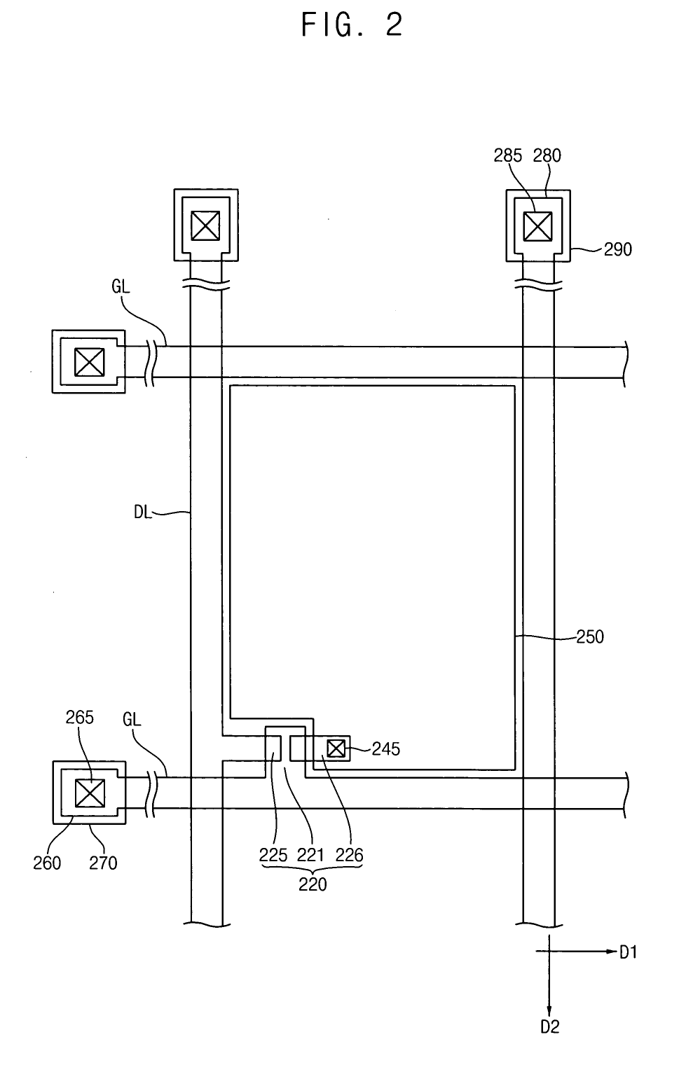

FIG. 2 is a plan view illustrating the array substrate in FIG. 1.

Referring to FIGS. 1 and 2, an LCD device includes an LCD panel 100 that displays an image and a backlight assembly (not shown) that provides the LCD panel 100 with light.

The LCD panel 100 includes an array substrate 200, a color filter substrate 300 facing the array substrate 200 and a liquid crystal layer 400 that is disposed between the array substrate 200 and the color filter substrate 300.

The LCD panel 100 includes a display area DA that displays an image, a first peripheral area PA1 that is disposed in a first side of the display area DA and a second peripheral area PA2 that is disposed in a second side of the display area DA.

A plurality of pixel areas is formed in the display area DA. The pixel areas are defined by a plurality of gate lines GL that is extended along a first direction D1, and a plurality of data lines DL that is extended along a second direction D2, which is substantially perpendicular to the first direction.

The array substrate 200 includes a thin-film transistor (TFT) 220, a passivation layer 230, a gate insulation layer 222, an organic insulating layer 240 and a pixel electrode 250. The TFT 220, the passivation layer 230, the organic insulating layer 240 and the pixel electrode are formed in each of the pixel areas of a first insulating substrate 210.

The TFT 220 may include a gate electrode 221, a semiconductor layer 223, an ohmic contact layer 224, a source electrode 225, and a drain electrode 226. The gate electrode 221 may be electrically connected to the gate line GL, and the source electrode 225 may be electrically connected to the data line DL. The drain electrode 226 may be electrically connected to the pixel electrode 250.

The gate insulation layer 222 is formed on the first insulating substrate 210 having the gate electrode 221 formed thereon. For example, the gate insulation layer 222 may include silicon nitride (SiNx). The semiconductor layer 223 and the ohmic contact layer 224 are sequentially formed on the gate insulation layer 222. The semiconductor layer 223 may include amorphous silicon. The ohmic contact layer 224 may include N+ amorphous silicon that is formed by implanting N+ impurities at a high concentration. For example, phosphorous (P) may be implanted into an upper portion of the semiconductor layer 223 to form the ohmic contact layer 224. The ohmic contact layer 224 is partially removed so that the semiconductor layer 223 is partially exposed.

The passivation layer 230 and the organic insulating layer 240 are formed on the first insulating substrate 210 having the TFT 220 formed thereon. The passivation layer 230 and the organic insulating layer 240 have a contact hole 245 that partially exposes the drain electrode 226 of the TFT 220. That is, the passivation layer 230 and the organic insulating layer 240 are partially removed in order to form the contact hole 245 exposing the drain electrode 226.

The pixel electrode 250 is formed on the organic insulating layer 240. The pixel electrode 250 transmits a first light L1 that is generated by the backlight assembly (not shown) and enters through the first insulating substrate 210. The pixel electrode 250 is electrically connected to the drain electrode 226 of the TFT 220 through the contact hole 245.

The organic insulating layer 240 includes an organic material 242 and a plurality of reflective particles 244. That is, the organic insulating layer 240 is a mixture of the reflective particles 244 and the organic material 242.

The organic material 242 may include a photosensitive organic material of which characteristics are changed when light is applied thereto. Alternatively, the organic material 242 may include a non-photosensitive organic material of which characteristics are not changed even when light is applied thereto. The reflective particles 244 may include a medium that is to be colored, and a pearl pigment that is coated on the medium to be colored. For example, the pearl pigment may be a pearlescent (nacreous) pigment, which is a special type of pigment that is used to simulate a visual effect of a metallic appearance.

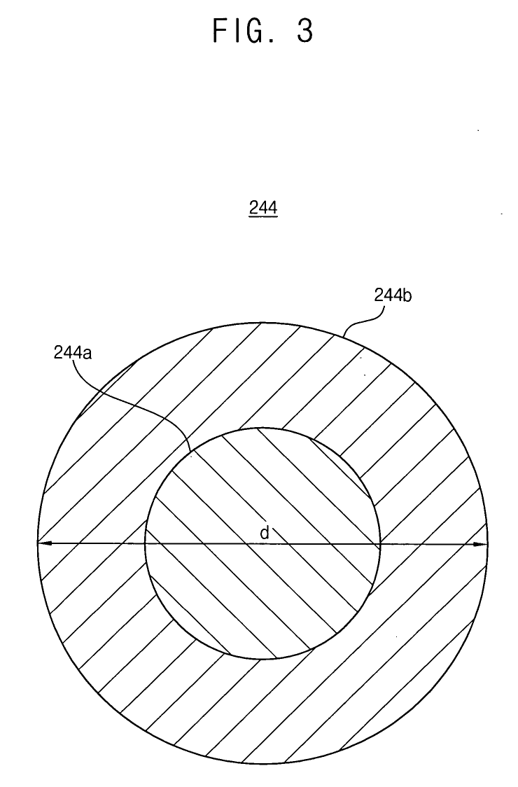

FIG. 3 is a cross-sectional view illustrating a reflective particle in FIG. 1.

Referring to FIGS. 1 and 3, each of the reflective particles 244 includes silicate (MICA) 244a and an oxide coating layer 244b. The oxide coating layer 244b is coated on the silicate (MICA) 244a. A diameter (d) of each of the reflective particles 244 is in a range of about 0.1 μm to about 5 μm. A refractive index of the each of the reflective particles 244 is in a range of about 1 to about 2.

For example, the oxide coating layer 244b may include titanium oxide (TiO₂), aluminum oxide (Al₂O₃), or tin oxide (SnO₂).

An incident light that is applied to the reflective particles 244 is reflected due to a refractive index difference between the silicate (MICA) 244a and the oxide coating layer 244b. When a diameter (d) of each of the reflective particles 244 is decreased, a reflecting ratio of the reflected light is increased. Additionally, when a refractive index of a surface is increased, a reflecting ratio of the reflected light is increased.

Referring again to FIGS. 1 and 2, the organic insulating layer 240 reflects a second light L2 that enters the LCD panel 100 through a color filter substrate 300 by using the reflective particles 244. The organic insulating layer 240 is partially removed to form a transmitting window 500. The transmitting window 500 and the contact hole 245 may be formed through the same process. Additionally, a pixel electrode 250 is formed in the transmitting window 500.

The organic insulating layer 240 corresponding to the transmitting window 500 is removed such that the passivation layer 230 is partially exposed. An area corresponding to the transmitting window 500 defines a transmitting area, and an area corresponding to the organic insulating layer 240 disposed under the pixel electrode 250 defines a reflective area. A first light L1 that is generated from the backlight assembly passes through the transmitting area, thereby displaying an image. A second light L2 that has entered from the exterior passes through the color filter substrate 300, and is reflected by the reflective particles 244 of the organic insulating layer 240, thereby displaying an image.

The first light L1 is transmitted through the transmitting window 500, and the second light L2 is reflected by the reflective particles 244. In other words, the organic insulating layer 240 has a transmitting function and a reflecting function. Therefore, the organic insulating layer 240 may be referred to as a transflective film.

A gate electrode pad 260 extending from the gate line GL has a larger width than that of the gate line GL, and is formed in the first peripheral area PAl. A first via hole 265 partially exposing the gate electrode pad 260 is formed in the first peripheral area PA1. The first via hole 265 is formed by removing a portion of the gate insulating layer 221, the passivation layer 230 and the organic insulating layer 240, which is disposed upon the gate electrode pad 260.

A first transparent electrode 270 is formed on the gate electrode pad 260. The first transparent electrode 270 is electrically connected to the gate electrode pad 260 through the first via hole 265. The first transparent electrode 270 and the pixel electrode 250 may be formed from the same layer. For example, the first transparent electrode 270 and the pixel electrode 250 may be formed through the same process.

A data electrode pad 280 extending from the data line DL has a larger width than that of the data line DL, and is formed in the second peripheral area PA2. Portions of the passivation layer 230 and the organic insulating layer 240, which are disposed upon the data electrode pad 280, are removed to form a second via hole 285. The second via hole 285 partially exposing the data electrode pad 280 is formed in the second peripheral area PA2.

A second transparent electrode 290 that is electrically connected to the data electrode pad 280 through the second via hole 285 is formed upon the data electrode pad 280. The second transparent electrode 290 and the pixel electrode 250 may be formed from the same layer. For example, the second transparent electrode 290 and the pixel electrode 250 may be formed through the same process.

Each of the gate electrode pad 260 and the data electrode pad 280 is electrically connected to a flexible printed circuit board (PCB) (not shown) through an anisotropic conductive film (ACF, not shown). Therefore, the gate electrode pad 260 outputs a gate signal that is received from the flexible PCB to a gate line (GL), and the data electrode pad 280 outputs a data signal that is received from the flexible PCB to a data line (DL).

The color filter substrate 300 includes a light-shielding layer 320, a color filter 330, and a common electrode 340, which are formed on a second insulating substrate 310. The color filter 330 includes a red pixel, a green pixel, and a blue pixel. The light-shielding layer 320 is formed between the color filter 330, so that the light-shielding layer 320 shields leaked light from a gap in the color filter 330. The common electrode 340 faces the pixel electrode 250 that is formed on the array substrate 200.

In the LCD device as described above, the second light L2 is reflected by the reflective particles 244 of the organic insulating layer 240. Therefore, a conventional reflective electrode may be unnecessary. Also, reflecting amounts of the second light L2 are increased by dispersion and interference of light in the reflective particles 244, and a viewing angle is enhanced. Therefore, embossing patterns for dispersion and interference may be unnecessary.

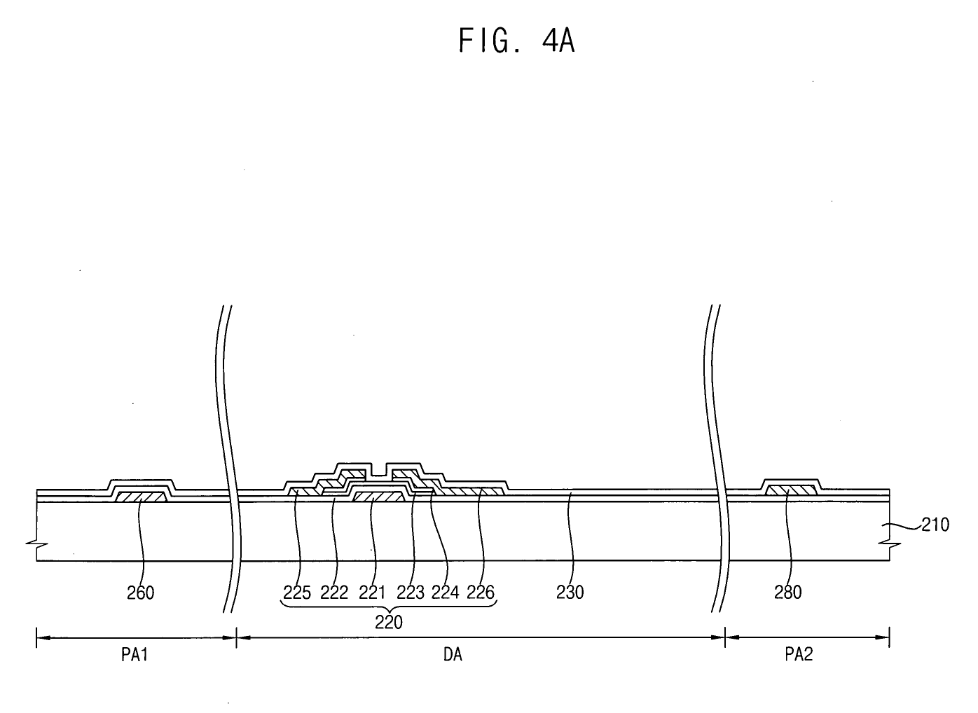

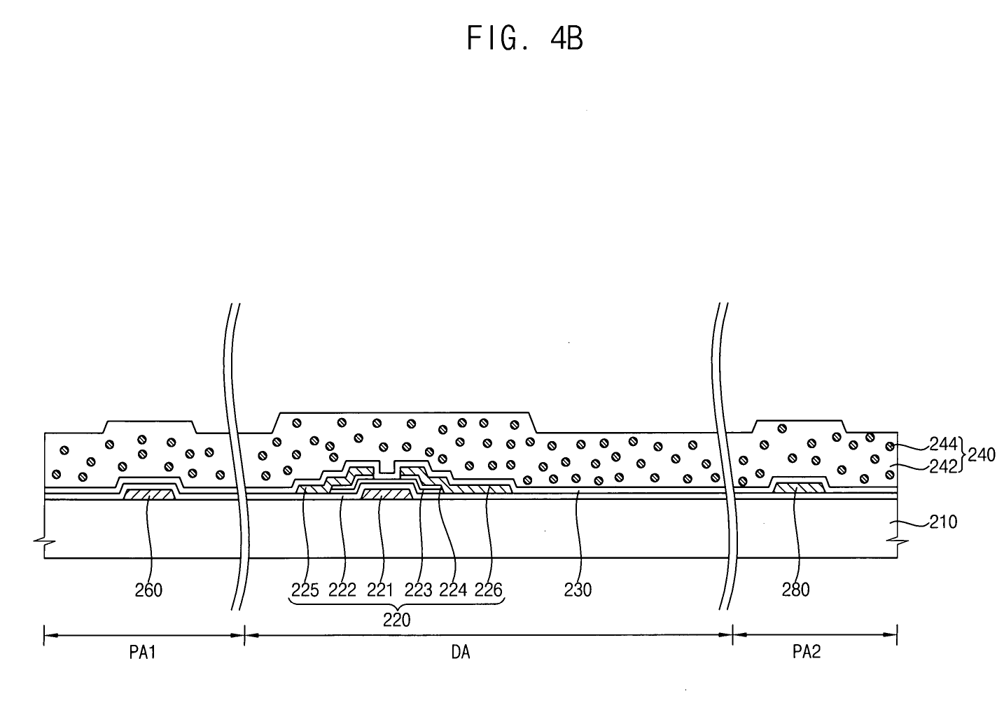

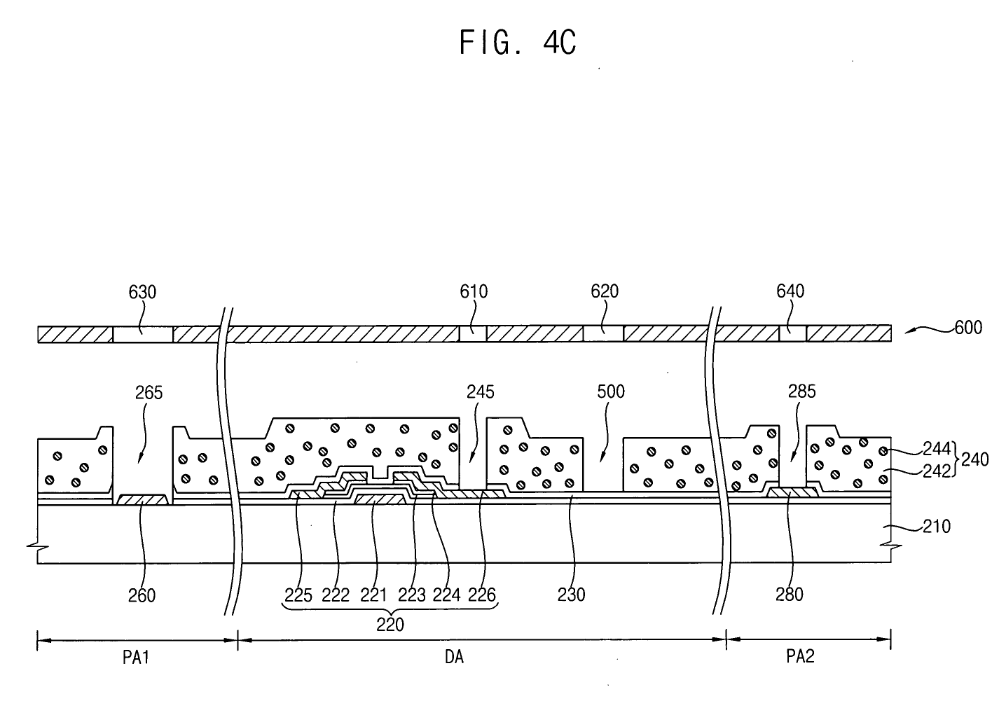

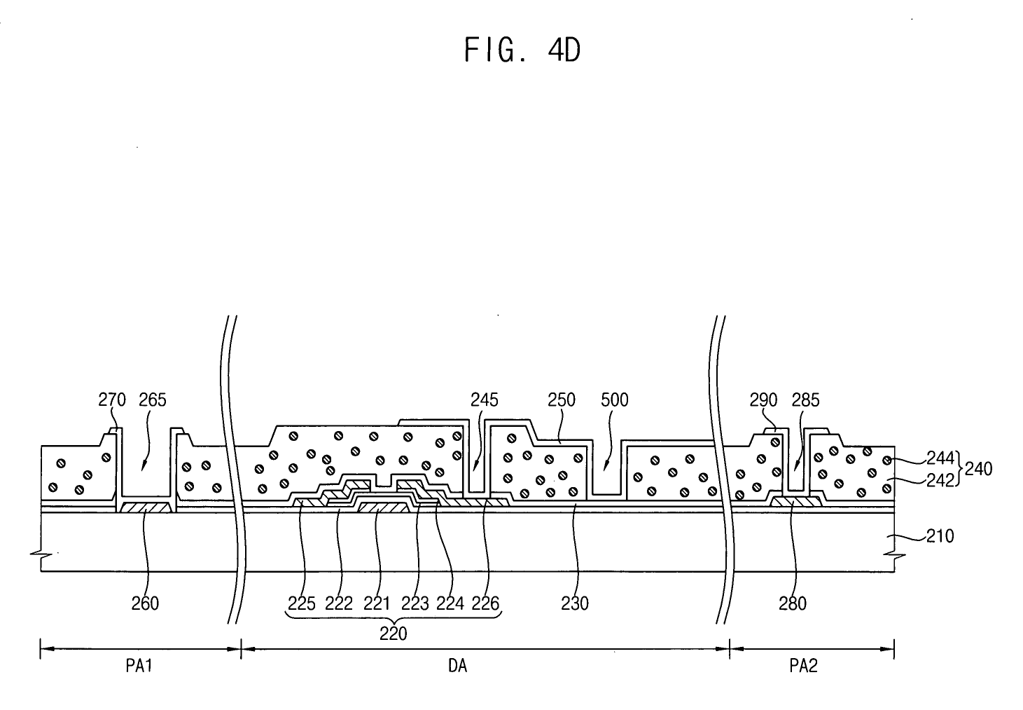

FIGS. 4A to 4D are cross-sectional views illustrating a method of manufacturing an array substrate according to an exemplary embodiment of the array substrate in FIG. 1.

Referring to FIG. 4A, a first metal layer (not shown) is formed on a first insulating substrate 210, and then the first metal layer is patterned to form a gate electrode 221 and a gate electrode pad 260. The gate electrode 221 is formed on a display area DA, and a gate electrode pad 260 is formed on a first peripheral area PA1.

Then, a silicon nitride layer is formed on the first insulating substrate 210 having the gate electrode 221 and the gate electrode pad 260 formed thereon to form a gate insulation layer 222. An amorphous silicon layer and an N+ amorphous silicon layer are sequentially formed on the gate insulation layer 222 to form a semiconductor layer 223 and an ohmic contact layer 224, respectively.

A second metal layer (not shown) is deposited on the first insulating substrate 210 having the semiconductor layer 223 and the ohmic contact layer 224 formed thereon, and then the second metal layer is patterned in a display area DA to form a source electrode 225 and a drain electrode 226. Additionally, a data electrode pad 280 may be formed in a second peripheral area PA2.

Therefore, a TFT 220 having the gate electrode 221, the semiconductor layer 223, the ohmic contact layer 224, the source electrode 225 and the drain electrode 226 is formed on the display area DA of the first insulating substrate 210. Moreover, the gate electrode pad 260 is formed in the first peripheral area PA1, and the data electrode pad 280 is formed in the second peripheral area PA2.

Referring to FIG. 4B, a protecting layer 230 is formed on the first insulating substrate 210 having the TFT 220 formed thereon, the gate electrode pad 260 and the data electrode pad 280. Then, a material including the reflective particles 244 mixed with the organic material 242 having photosensitive characteristics is deposited on the first insulating substrate 210 having the TFT 220 formed thereon, for example, through a spin coating process or a slit coating process so that an organic insulating layer 240 is formed on the first insulating substrate 210. The organic insulating layer 240 is formed in the display area DA, and the first and second peripheral areas PA1 and PA2.

As shown in FIG. 4C, a mask 600 having a predetermined pattern is disposed over the organic insulating layer 240. The mask 600 may include a first opening 610 for forming a contact hole 245, a second opening 620 for forming a transmitting window 500, a third opening 630 for forming a first via hole 265 and a fourth opening 640 for forming a second via hole 285.

After the organic insulating layer 240 is exposed through the mask 600, the exposed organic insulating layer 240 is developed using a developer solution. Since the organic insulating layer 240 has photosensitive characteristics, the exposed area is developed. Therefore, a portion of the organic insulating layer 240 and the passivation layer 230, which corresponds to the first opening portion 610, is removed, so that a contact hole 245 that exposes the drain electrode 226 is formed. Additionally, a portion of the organic insulating layer 240, which corresponds to the second opening portion 620, is exposed, so that a transmitting window 500 that exposes the passivation layer 230 is formed. Additionally, a portion of the organic insulating layer 240, the passivation layer 230 and the gate insulating layer 222, which corresponds to the opening portion 630, is partially exposed, so that a first via hole 265 that exposes the gate electrode pad 260 is formed. Additionally, a portion of the organic insulating layer 240 and the passivation layer 230, which corresponds to the fourth opening portion 640, is exposed, so that a second via hole 285 that exposes the data electrode pad 280 is formed.

Referring to FIG. 4D, a transparent conductive layer including indium tin oxide (ITO) or indium zinc oxide (IZO) is formed on the first insulating substrate 210 having a contact hole 245, a transmittance window 500 and first and second via holes 265 and 285 formed thereon, and the transparent conductive layer is patterned. As a result, the pixel electrode 250 is formed on the display area DA, the first transparent electrode 270 is formed on the first peripheral area PA1, and the second transparent electrode 290 is formed on the second peripheral area PA2 to complete the array substrate 100.

The pixel electrode 250 described above is electrically connected to the drain electrode 225 through the contact hole 245. The first transparent electrode 270 is electrically connected to the gate electrode pad 260 through the first via hole 265, and the second transparent electrode 290 is electrically connected to the data electrode pad through the second via hole 285.

The array substrate 200 that is manufactured by the above mentioned manufacturing process reflects the second light L2 by using the reflective particles 244 of the organic insulating layer 240. Therefore, a process that forms a conventional reflective electrode may be unnecessary. Also, reflecting amounts of the second light L2 may be increased by dispersion and interference of light in the reflective particles 244, and a viewing angle may be enhanced. Therefore, a process that forms conventional embossing patterns may be unnecessary, and a process of manufacturing the array substrate may be simplified.

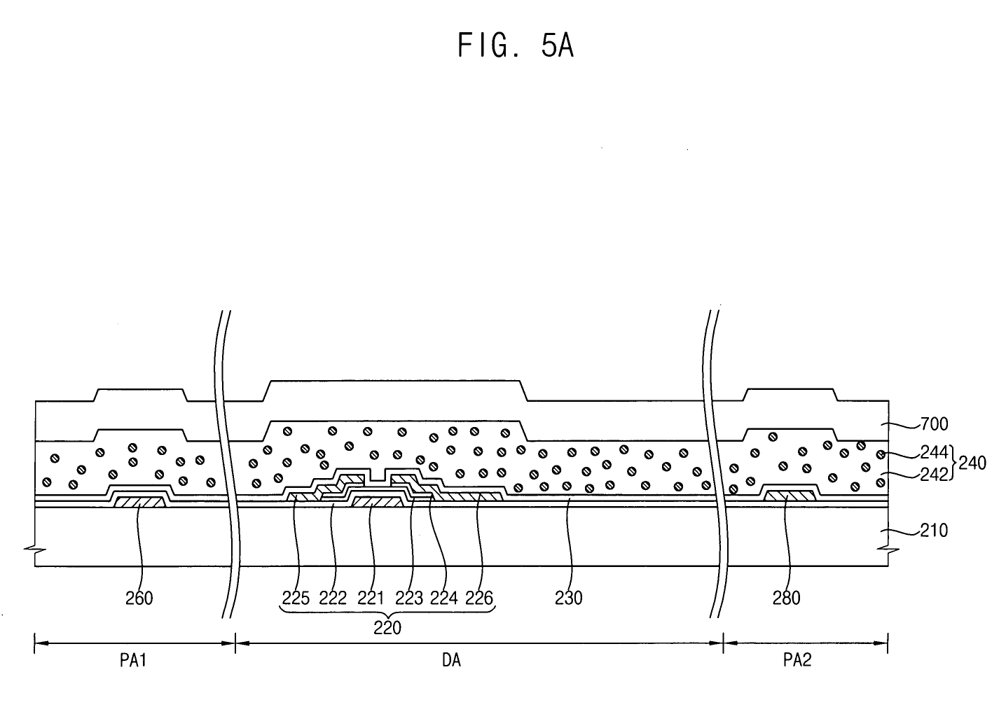

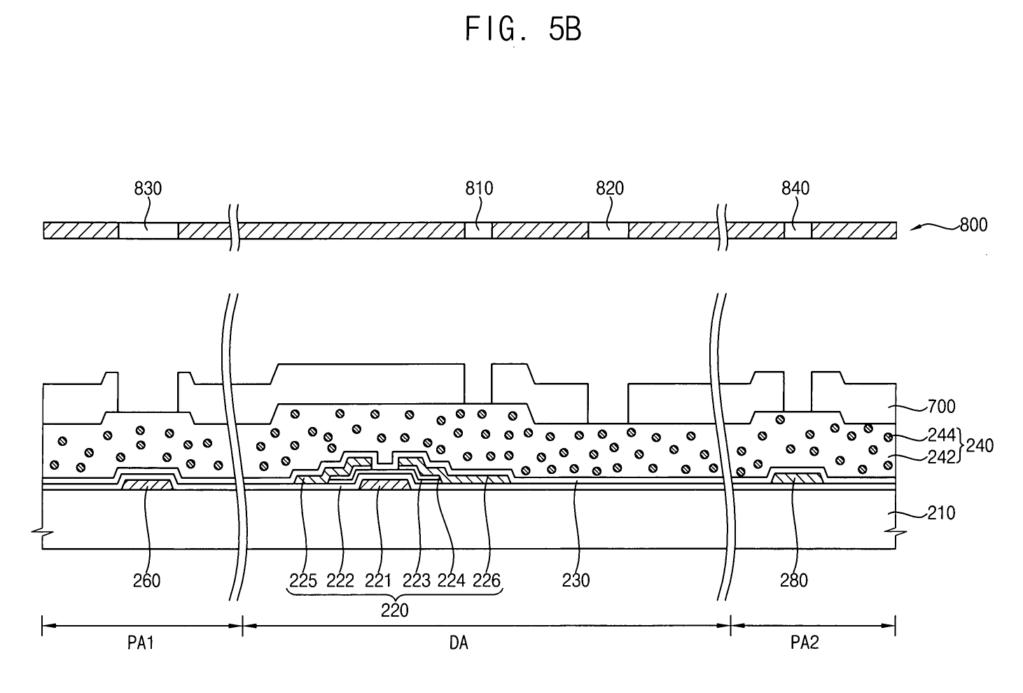

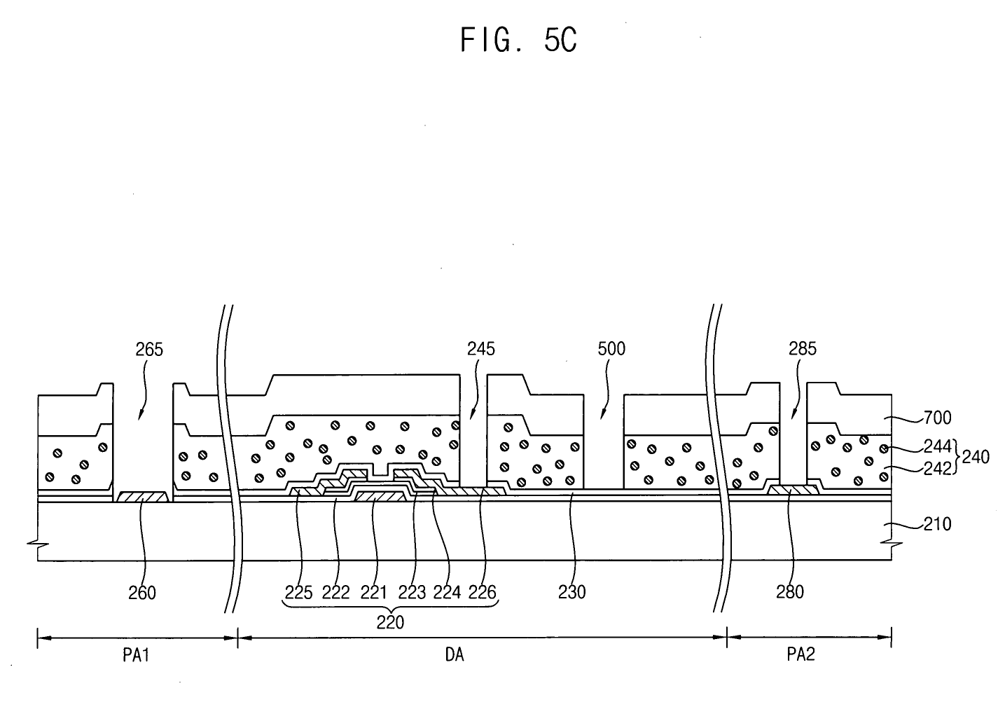

FIGS. 5A to 5C are cross-sectional views illustrating a method of manufacturing an array substrate according to an exemplary embodiment of the array substrate according to FIG. 1.

Referring to FIG. 1 and FIG. 5A, the switching element 220 is formed on the first insulating substrate 210. The gate electrode pad 260 and the data electrode pad 280 are formed on the first and second peripheral areas PA1 and PA2, respectively.

The passivation layer 230 is formed on the first insulating substrate 210 on which the TFT 220, the gate electrode pad 260 and the data electrode pad 280 are formed, so that the passivation layer 230 covers the TFT 220, the gate electrode pad 260 and the data electrode pad 280. A material including a non-photosensitive organic material 242 and reflective particles 244 is coated on the passivation layer 230 of the first insulating substrate 210, for example, through a spin coating process or a slit coating process, so that the organic insulating layer 240 is formed on the passivation layer 230. The organic insulating layer 240 is formed in the display area DA and the first and second peripheral areas PA1 and PA2.

Then, a photoresist film 700 having photosensitive characteristics is formed on the organic insulating layer 240 that is formed on the first insulating substrate 210.

Referring to FIG. 5B, a mask 800 having a pattern shape is disposed over the photoresist film 700. The mask 800 has a first opening portion 810 to form a contact hole 245, a second opening portion 820 to form a transmittance window 500, a third opening portion 830 to form a first via hole 265 and a fourth opening portion 840 to form a second via hole 285.

Then, the photoresist film 700 is exposed by the mask 800, and the exposed photoresist film 700 is developed by a developer solution. Therefore, the photoresist film 700 is partially removed at regions corresponding to the first to fourth opening portions 810, 820, 830 and 840, so that the organic insulating layer 240 is patterned.

Referring to FIG. 5C, a dry etching process is performed by an etching gas through a mask, which is the patterned photoresist film 700. The etching gas includes sulfur fluoride (SF₆), oxygen gas (O₂), and nitrogen gas (N₂).

The organic insulating layer 240 and the passivation layer 230 corresponding to the first opening portion 810 are removed by the dry etching process, so that a contact hole 245 is formed. The organic insulating layer 240 corresponding to the second opening portion 820 is removed by the dry etching process, so that a transmitting window 500 is formed. The organic insulating layer 240, the passivation layer 230 and the gate insulating layer 830 corresponding to the third opening portion 830 are removed by the dry etching process, so that a first via hole 265 is formed. The organic insulating layer 240 and the passivation layer 230 corresponding to the fourth opening portion 840 are removed by the dry etching process, so that a second via hole 285 is formed.

Then, the patterned photoresist film 700 is removed. A transparent conductive layer including ITO or IZO is coated with a uniform thickness, and patterned. Therefore, the pixel electrode 250, the first transparent electrode 270 and the second transparent electrode 290 are formed in the display area DA, the first peripheral area PA1 and the second peripheral area PA2, respectively. Accordingly, the array substrate 100 is completed.

Hereinbefore, the transflective-type LCD device having a transmitting area that transmits the first light L1 and a reflective area that reflects the second light L2 is described. Alternatively, the reflective particles 244 of the organic insulating layer 240 as described above may also be used for a reflective-type LCD. That is, the reflective-type LCD has an organic insulating layer 240 having a reflective area that reflects the second light L2 through the reflective particles 244 of the organic insulating layer 240. Hence, in the organic insulating layer 240, the transmitting window 500 is not formed thereon.

As described the above, the array substrate according to the present invention may include an organic insulating layer having an organic material and the reflective particles. The transmitting window may be formed in the organic insulating layer so as to transmit light.

The organic insulating layer may transmit an internal light, namely the first light that is outputted from the backlight assembly through the transmitting window, and may reflect an ambient light, namely the second light, such as sunlight, by using the reflective particles.

Accordingly, the array substrate and the LCD device according to an exemplary embodiment of the present invention may not require a conventional reflective electrode that reflects the ambient light. Also, the array substrate and the LCD device according to an exemplary embodiment of the present invention may reflect the ambient light with an enhanced reflecting efficiency by using the reflective particles of the organic insulating layer. Furthermore, the array substrate and the LCD device according to an exemplary embodiment of the present invention may have a enhanced viewing angle, so that a conventional micro-lens may not be required. Furthermore, a process that forms a reflective electrode or embossing patterns may be unnecessary in a manufacturing process of the array substrate, so that a manufacturing process of an array substrate or an LCD device may be simplified.

Although the illustrative embodiments of the present invention have been described herein with reference to the accompanying drawings, it is to be understood that the present invention should not be limited to those precise embodiments, and that various other changes and modifications may be affected therein by one of ordinary skill in the related art without departing from the scope or spirit of the invention. All such changes and modifications are intended to be included within the scope of the invention as defined by the appended claims.

What is claimed is:

1. An array substrate comprising:
a substrate;
a switching element that is formed in a display area of the substrate;
an insulating layer that is formed on the substrate having the switching element formed thereon, the insulating layer containing a plurality of reflective particles reflecting light incident into upper portion of the substrate; and
a pixel electrode formed on the insulating layer, the pixel electrode being electrically connected to the switching element.

2. The array substrate of claim 1, wherein the insulating layer comprises a mixture of a photosensitive organic material and the reflective particles.

3. The array substrate of claim 1, wherein the insulating layer includes a mixture of a non-photosensitive organic material and the reflective particles.

4. The array substrate of claim 1, wherein each of the reflective particles includes a silicate particle and a metal oxide coating layer that is coated on a surface of the silicate particle.

5. The array substrate of claim 4, wherein the metal oxide coating layer includes a material selected from the group consisting of titanium oxide (TiO₂), aluminum oxide (Al₂O₃) and tin oxide (SnO₂).

6. The array substrate of claim 1, wherein each of the reflective particles has a diameter of about 0.1 μm to about 5 μm.

7. The array substrate of claim 1, wherein each of the reflective particles has a refractive index of about 1 to about 2.

8. The array substrate of claim 1, wherein the insulating layer has a transmitting window that transmits light that is received from a lower portion of the substrate.

9. A method of manufacturing an array substrate comprising:
forming a substrate;
forming a switching element in a display area of the substrate;
forming an insulating layer on the substrate having the switching element formed thereon, the insulating layer containing a plurality of reflective particles that reflects light incident into an upper portion of the substrate; and
forming a pixel electrode on the insulating layer, the pixel electrode being electrically connected to the switching element.

10. The method of claim 9, wherein forming the insulating layer comprises:
coating a mixture material including a photosensitive organic material and the reflective particles on the substrate having the switching element formed thereon;
exposing the mixture material that is coated on the substrate having the switching element formed thereon through a mask; and
forming a contact hole that partially exposes the switching element.

11. The method of claim 10, wherein forming the insulating layer further comprises:
forming a transmitting window that transmits light that is received from a lower portion of the substrate simultaneously when forming the contact hole.

12. The method of claim 9, wherein forming the insulating layer further comprises:
coating a mixture material including a non-photosensitive organic material and the reflective particles on the substrate having the switching element formed thereon;
coating a photoresist film on the mixture material;
patterning the photoresist film to form a patterned photoresist film through a mask;
forming a contact hole that partially exposes the switching element by etching the mixture material using the patterned photoresist film; and
removing the patterned photoresist film.

13. The method of claim 12, wherein the forming the insulating layer further comprises:
forming a transmitting window that transmits light that is received from a lower portion of the substrate simultaneously with the step of forming the contact hole.

14. The method of claim 9, wherein each of the reflective particles includes a silicate particle and a metal oxide coating layer that is coated on a surface of the silicate particle.

15. The method of claim 14, wherein the metal oxide coating layer includes a material selected from the group consisting of titanium oxide (TiO₂), aluminum oxide (Al₂O₃) and tin oxide (SnO₂).

16. A liquid crystal display (LCD) device comprising:
a color filter substrate;
an array substrate facing the color filter substrate, the array substrate including a substrate, a switching element that is formed in a display area of the substrate, an insulating layer that is formed on the substrate having the switching element formed thereon, the insulating layer containing a plurality of reflective particles reflecting light incident into upper portion of the substrate, and a pixel electrode formed on the insulating layer, the pixel electrode being electrically connected to the switching element; and
a liquid crystal layer that is disposed between the color filter substrate and the array substrate.

17. The LCD device of claim 16, wherein the insulating layer includes a photosensitive organic material and the reflective particles.

18. The LCD device of claim 16, wherein the insulating layer includes a non-photosensitive organic material and the reflective particles.

19. The LCD device of claim 16, wherein each of the reflective particles includes a silicate particle and a metal oxide coating layer that is coated on a surface of the silicate particle.

20. The LCD device of claim 19, wherein the metal oxide coating layer includes a material selected from the group consisting of titanium oxide (TiO₂), aluminum oxide (Al₂O₃) and tin oxide (SnO₂).
